(19) United States
(12) Patent Application Publication
(10) Pub. No.: US 2006/0294549 A1
(43) Pub. Date: Dec. 28, 2006

(54) Method, system, administration unit and terminal for the detection, representation and modification of parameters and parameter values, e.g. bandwidth or costs, of at least one section of a connection between a server and a terminal

(76) Inventor: Sigram Schindler, Berlin (DE)

Correspondence Address: NOVAK DRUCE & QUIGG, LLP, 1300 EYE STREET NW, 400 EAST TOWER, WASHINGTON, DC, 20005, US

(21) Appl. No.: 10/555,430

(22) PCT Filed: Apr. 30, 2004
(86) PCT No.: PCT/DE04/00992

§ 371 Date: May 18, 2006

(30) Foreign Application Priority Data
May 5, 2003 (DE) 103 20 696.5

(51) Int. Cl. H04N 5/445

(52) U.S. Cl. 725/48; 725/8

(57) ABSTRACT

The invention relates to a method for the transfer of information between a terminal of at least one communication network and an administration unit in the communication network, in addition to a communication system, an administration unit and a communication terminal in order to carry out said method. According to the invention, parameters and parameter values of a connection between a server and the terminal are detected by the administration unit and are stored in a data base of the administration unit. The administration unit produces one or more messages (DOWNSTREAM-MS-iD-Info) which contain at least one of the following pieces of information:—the sequence or part of the sequence of the data transfer section currently used in the connection between the server and the terminal,—at least one parameter and parameter value of at least one data transfer section of said current sequence,—at least one alternative sequence or part of an alternative sequence of data transfer sections between the server and the terminal,—at least one alternative sequence or part of an alternative sequence of data transfer sections between the server and the terminal,—at least one parameter and parameter value of at least one data transfer section of said alternative sequence. The messages are transferred to the terminal, where they are used, especially, represented automatically for the user of the terminal. The terminal or the administrator of a data transfer section (6-1, 6-2, 6-3) can send a modification request message to the administration unit, whereby, for example, either the band width of the connection in said section is altered or an alternative section, for example, is selected via another access network. A management system is provided, enabling the stored data to have an optimum connection(s) by means of a predefined target function.

The invention relates to a method of information transmission between a terminal of at least one communication network and an administration unit in the communication network according to the preamble of claim 1, in addition to a communication system, an administration unit and a communication terminal in order to carry out said method.

### BACKGROUND OF THE INVENTION

In the telecommunication and computer network area, connections have a multiplicity of data transmission sections which are connected together for establishing a connection and transmitting data between a transmitting unit and a receiving unit.

As a rule, there is a multiplicity of possibilities of building up chains of data transmission sections to a user. The “chain”, also called media sequence in the text which follows, which is in each case used is usually determined by a management system. Apart from determining the sequence of data transmission sections used in each case, characteristics of the respective data transmission sections must also be determined, particularly the bandwidth of the data transmission for the connection considered. This, too, is regulated by the management system, this term quite generally designating each system which is involved in determining the data transmission sections of a connection or characteristics of the data transmission sections of a connection.

An example consists in the transmission of data from a proxy server to a terminal, using satellite-based data transmission sections. Data to be transmitted to a terminal, for example from a server of the Internet, are initially transmitted to the proxy server and from there via the satellite link to the terminal, which, for example, is directly associated with a satellite receiving dish or which receives the data via a local network or cable network in which the received data are fed. Such a method is described in EP 0 998 093 B1.

In the above example of satellite-based data transmission sections, a possible choice of the media sequence lies, for example, in the satellite used (if a number of satellites are used), in the transponder used on a satellite and in the frequency, frequency position and polarization used for the data radiated by a transponder.

When a multiplicity of connections are administered by a management system, it is then obvious that a change of a media sequence or of parameters and parameter values of individual sections of a media sequence, triggered, for example, by external events or inputs by a user, also directly affects the media sequences of the other connections and their characteristics. If, for example, a user requests a greater bandwidth for transmitting a large data file, the management system must redistribute the existing resources for the data transmission. The optimum way of doing this in the case of a multiplicity of users must be solved by mathematical optimization methods. In the literature, this problem is also called “load balancing”.

A downstream problem of no lesser significance consists in providing an administration system with the required information on the basis of which a management system can then determine the optimum utilization of a communication network and the media sequences which can be implemented in it, where the wishes of the users of the communication network should also be considered, if possible.

### OBJECT OF THE INVENTION

Accordingly, the present invention has the basic object of providing a method of information transmission between a terminal of at least one communication network and an administration unit in the communication network which provides a basis for the optimum utilization of a communication network and the media sequences which can be implemented in it and at the same time can also take into consideration the wishes of the users of the communication network. Furthermore, a communication system, an administration unit and communication terminal for carrying out the method are to be provided.

### BRIEF DESCRIPTION OF THE INVENTION

This object is achieved by a method having the features of claim 1, a communication system having the features of claim 25, an administration unit having the features of claim 18 and a communication terminal having the features of claim 29. Advantageous and preferred embodiments of the invention are specified in the subclaims.

Accordingly, the solution according to the invention is characterized by the fact that in an administration unit, parameters and parameter values of a connection between a server and a terminal are detected, stored in a central database, and its parameters or a subset of these parameters are sent to the terminal in the form of one or more messages. The administration unit administers the media sequences of a multiplicity of connections and, therefore, will also be called “media sequence administrator” (MS-Admin) in the text which follows. The messages transmitted are utilized at the terminal and, in particular, are represented to a user for this purpose.

The messages sent by the administration unit to the terminal, also called DOWNSTREAM-M(edia)S(equence)-iD-Info in the text which follows, contain at least one of the following items of information:
the sequence or a subset of the sequence of the data transmission sections currently used in the connection between the server and the terminal (media sequence),
at least one parameter and parameter value of at least one data transmission section of this current sequence,
at least one alternative sequence or subset of an alternative sequence of data transmission sections between the server and the terminal;
at least one parameter and parameter value of at least one data transmission section of this alternative sequence.

The method according to the invention enables parameters and parameter values to be detected, transmitted, represented and forwarded to media sequences used currently or in future. The parameters and parameter values stored in a database of the administration unit can be provided to a management system which optimizes this information for the communication network and its current user requirements in accordance with a predetermined target function. At the terminal, the information provided enables a user of the terminal to make decisions about the parameters and parameter values of the existing connection, particularly with regard to the costs and bandwidth of the data transmission. It is thus possible to provide and possibly modify the media sequence of a connection by taking into consideration the wishes of the user.

The DOWNSTREAM-MS-iD-Info messages are preferably additionally transmitted to one or more administrators of the data transmission sections of the connection considered and are there evaluated. The administrators in each case monitor and control the load balance of a particular data transmission section and report this information to the administration unit.

In a preferred embodiment of the invention, a message (UPSTREAM-MS-ID-Info) is also generated at the terminal and/or at least one administrator of a data transmission section of its current media sequence and sent to the administration unit. This UPSTREAM message has at least one of the following items of information:
the media sequence of the data transmission sections currently used in the connection between the server and the terminal, possibly from the perspective of the terminal or of its user respectively, or of a DT-section administrator,
an alternative media sequence desired from the perspective of the terminal or an administrator of a data transmission section, for this connection between server and terminal,
a desired current minimum bandwidth or one that is available within a certain future, for the data transmission between the server and the terminal,
desired costs for the data transmission between the server and the terminal,
other desired parameters and/or parameter values of the connection between the server and the terminal,
parameters and/or parameter values of system components which characterize the connection of the terminal to communication networks which enable it to communicate with the server, particularly
information about the parameters of a satellite receiving dish and its current and alternative connection to the terminal,
if the terminal or its user or an administrator of a data transmission section of the current connection of the terminal to the server wishes a modification of the parameters or parameter values of the current connection, information relating to the desired modification.

In this context, the message sent out by an administrator of a data transmission section can be transmitted first to the terminal and from there on to the administration unit. The administrator of a data transmission section preferably also informs the administration unit, if the terminal is located in “its” data transmission section or at the end of its data transmission section, so that the administration unit has information about the data transmission section in which the connection considered is terminated.

In a preferred embodiment, it is provided that the terminal or an administrator of a data transmission section automatically sends out a message (UPSTREAM-MS-iD-Info) as response to a message (DOWNSTREAM-MS-iD-Info) received from the administration unit. For example, the administration unit reports in the message that an alternative sequence of data transmission sections in a connection to the terminal can be implemented with a greater total bandwidth. The terminal thereupon informs the administration unit whether such an alternative media sequence is desired or not.

It is also possible that a message (UPSTREAM-MS-ID-Info) is generated at the terminal or by an administrator of a data transmission section and is transmitted to the administration unit when an alternative media sequence between the server and the terminal is desired by the terminal or its user, independently of whether a message has just been received by the administration unit. In this context, an alternative media sequence also includes the case that the current media sequence per se is not modified but at least one parameter or parameter value of at least one data transmission section of the current media sequence. For example, another bandwidth is provided on a currently used data transmission section.

In the administration unit, information relating to the question whether and to what extent modifications of one or more of the parameters and parameter values of the current connection imply or require the modification of parameters and parameter values of other connections of the communication network and possibly of other communication networks, is preferably also determined and stored in the database of the administration unit. Such information is also designated compound information. If, for example, a terminal requests a data transmission with an increased bandwidth, the bandwidth transmitted to other terminals over the data transmission section considered must be reduced or another data transmission section must be used for transmitting the information. This can lead to complex consequences for the data transmission sections used for other connections and the bandwidths provided in each case. Such compound information is preferably transmitted, in particular, to the administrators of the individual data transmission sections by means of the messages transmitted by the administration unit.

The information stored in the database of the administration unit is provided to a management system which optimizes this information in accordance with a predetermined target function for the communication network and its current user requirements. In this context, the management system controls a possible modification of the current connection including a modification of its parameters and/or parameter values in accordance with this optimization. In the terminology of optimization theories, the database of the administration unit represents a decision space in which a target function exists which must be maximized or minimized. The optimization has the aim of providing the individual connections with the least possible expenditure of resources in the most cost-effective manner possible and with the greatest possible bandwidth, taking into consideration inputs from the users, if possible.

However, the optimization of the communication network in accordance with a predetermined target function, to be performed by the management, is not the actual subject matter of the present invention. Rather, the present invention collects in a central database the information forming a decision space for the management system. At the same time, the present invention provides for active participation of the end user in the choice of parameters of the connection set up to him, and a consideration of his wishes and concepts with regard to the parameters of the connection and quality and costs of the data transmission, respectively. This is done by sending special information packets from the administration unit to the terminal and preferably also from the terminal to the administration unit.

On reception of a message from the terminal or an involved administrator of a data transmission section, by means of which the wish for a modification of the current connection is signaled, the administration unit initiates an analysis of the feasibility of the desired change, coordinates it itself or releases it to the management system for further coordination. As a rule, the latter will be the case since the administration unit does not perform the actual optimization of the communication network in accordance with the desired target function but only collects information required for this purpose.

The current media sequence can be modified “actively” or “passively”. In the former case, the user requests, for example, a modification of the connection for the purpose of providing a higher or lower bandwidth. A passive modification can result from a modification of the parameters of the current media sequence which is the consequence of the modification of the media sequence of another connection. This is the result of the interdependence of the individual connections and of their parameters, respectively.

Correspondingly, the administration unit sends a message to the terminal, particularly if it proposes and/or initiates a modification of the parameters of its current connection to the server and/or this has taken place, where this modification can have taken place out of the current connection or from outside of the current connection. The administration unit by itself will demonstrate an alternative and more suitable media sequence for the connection between the terminal and the server to the terminal particularly if the quality of the data transmission on the current media sequence of the connection to the terminal does not correspond to a predetermined target function. The administration unit preferably receives the relevant information from the management system.

In principle, the data transmission sections used can be of arbitrary nature. In preferred exemplary embodiments, a data transmission section of a connection between terminal and server is satellite-based, TV cable-based, LAN-based, WLAN-based or telephony- or ISDN- or GSM- or GPRS- or UMTS- or microwave link-based. The transmission technologies used on the individual data transmission sections can also be of arbitrary nature. In particular, the data can be transmitted packetized or non-packetized and the individual data transmission sections can be part of a circuit-switched network or of a packet-switched network.

The connections implemented on the individual data transmission sections can operate, for example, by means of a so-called “short-hold technique” or by means of a “fast circuit switching technique”.

The server from which the data are transmitted to the terminal is preferably a proxy server which contains data of a multiplicity of other servers, particularly of a packet-switched network, and stores these for fast retrievability. The administration unit can be integrated in the proxy server or also in another server so that the two form one unit.

The communication system according to the invention has the following components:

an administration unit which detects and stores parameters and parameter values of a multiplicity of connections and their data transmission sections in a database,

a multiplicity of data transmission sections of the communication network,

at least one administrator of a data transmission section which sends current parameter values of the data transmission section to the administration unit, and

a management system which optimizes the communication network with regard to its current requirements on the basis of the information of the database of the administration unit in accordance with a predetermined target function, wherein

the administration unit for an existing connection generates at least one message with at least one parameter and parameter value of at least one data transmission section currently used or provided as an alternative for the connection, and sends this message to the terminal of the connection considered, to be used and represented there.

In this arrangement, the database of the administration unit preferably represents a central database which, if present, contains parameters and parameter values of a multiplicity of data transmission sections of the communication network. The data of this central database are provided to the management system.

The invention also relates to an administration unit and to a communication terminal as specified in claims 28 and 29. The means specified are preferably implemented by means of software.

### DESCRIPTION OF A NUMBER OF EXEMPLARY EMBODIMENTS

In the text which follows, the invention will be explained in greater detail by means of a number of exemplary embodiments, referring to the figures of the drawings, in which:

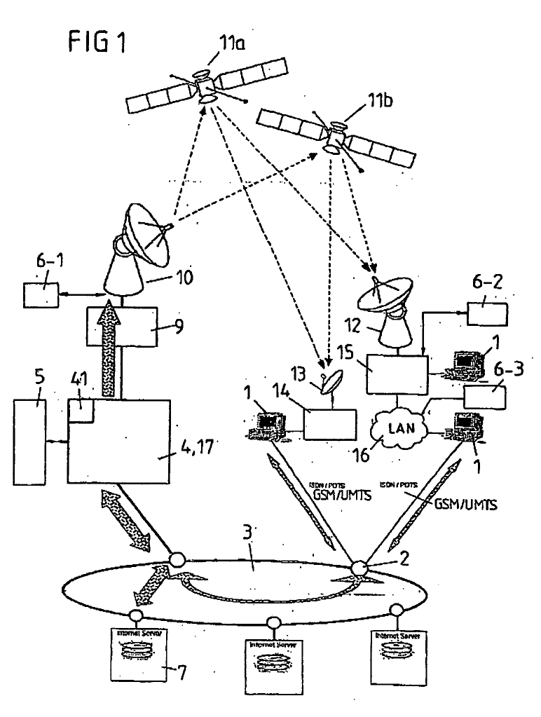

FIG. 1—diagrammatically shows a telecommunications network with a multiplicity of Internet servers, a proxy server with an integrated administration unit, a management system, a number of satellite transmission links and a number of terminals for receiving the data transmitted via the satellite transmission links;

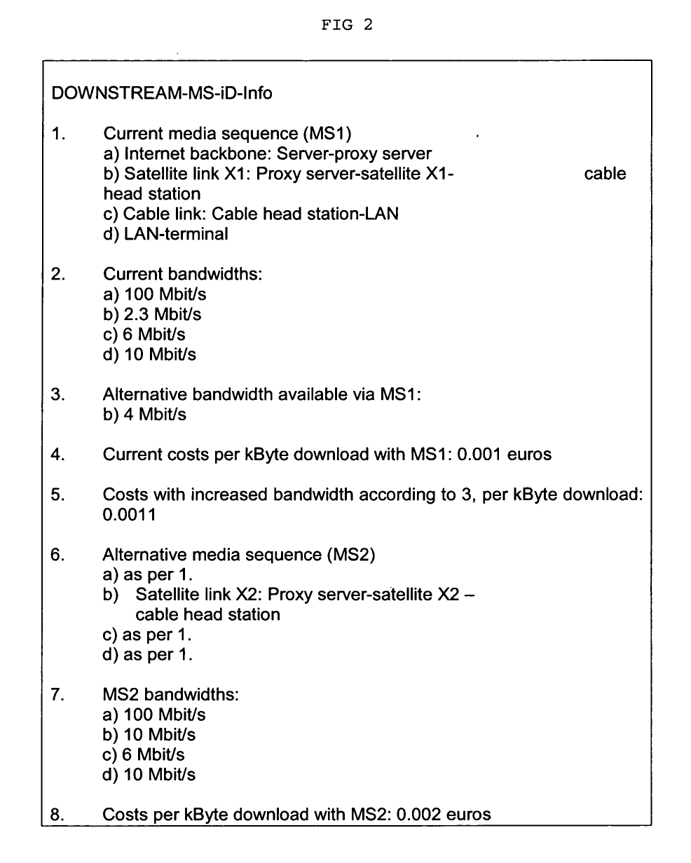

FIG. 2—shows an example of a message (DOWNSTREAM-MS-iD-Info) sent out to a terminal by the administration unit of FIG. 1;

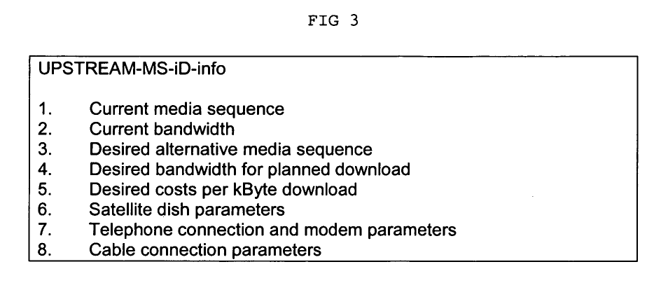

FIG. 3—shows an example of a message (UPSTREAM-MS-iD-Info) sent out to the administration unit by a terminal of FIG. 1; and

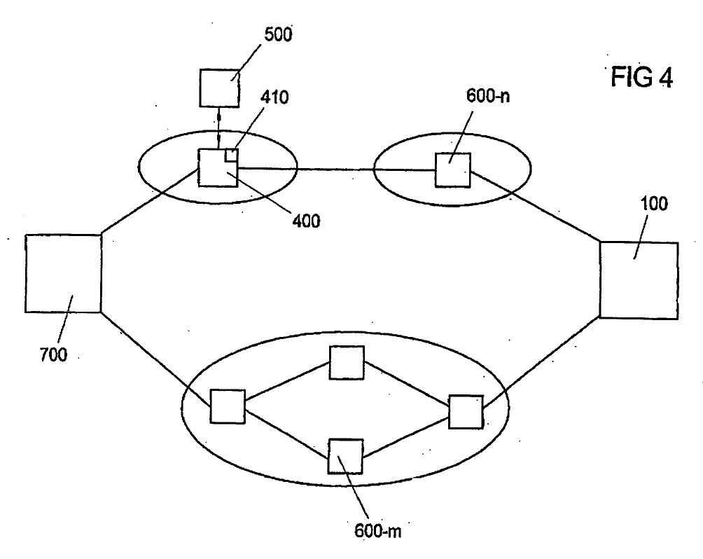

FIG. 4—diagrammatically shows a communication network in which a multiplicity of media sequences can be implemented between a transmitter and a receiver and in which an administration unit with an associated network management is arranged in a network node.

Firstly, an actual exemplary embodiment of the present invention will be described with reference to FIGS. 1 to 3.

FIG. 1 shows a communication structure in which a multiplicity of terminals 1 are connected via an ISDN/POTS/GSM/UMTS connection, which, as a rule, is narrow-band, or in any other way to a packet-switched network 3 particularly the Internet.

Apart from the connection to the Internet 3, each terminal 1 is furthermore in each case connected to a communication structure which receives data radiated by a satellite 11a, 11b and forwards them as broad-band signals to the terminal 1. In one exemplary embodiment, the terminal 1 receives the data radiated by a satellite via a satellite antenna 13 which is directly associated with the terminal and which is connected to the terminal 1 via a broadband receiving system 14, for example a PC card or an external box.

The satellite dish 13 can also be the receiving station of a satellite master antenna system.

In another example, the terminal 1 is connected to a television cable network into which broadband data are fed which are received by a cable station 12. It is also conceivable that the terminal 1 is connected to a local area network LAN 16 which is connected to a satellite receiving antenna 12 via the cable network or also directly.

In the Internet 3, there is a number of host computers or Internet servers 7 from which the user can download data selected by him. In principle, the data can be transmitted to the terminal via the narrowband ISDN/POTS/GSM/UMTS connection. However, it is preferably provided that the data to be transmitted are transmitted to the terminal 1 as broadband signals via a satellite 11a, 11b from the respective Internet server 7. For this purpose, the data to be transmitted are to be transmitted as broadband signals from the respective Internet server 7 to a proxy server 17 and from the latter with great bandwidth via satellite 11a, 11b to the terminal 1. In this arrangement, the data are transmitted from the proxy server 17 to a satellite uplink 9, sent by the satellite uplink 9 via a satellite antenna 10 to a satellite 11a, 11b, radiated by a transponder of the satellite 11a, 11b with a certain frequency and polarization and received as broadband signals via the satellite antenna 12, 13 associated with the respective terminal 1. Such a communication system is described in detail in EP 0 998 093 B1, reference to which is expressly made in this respect.

A connection between the terminal 1 and an Internet server 7 is preferably always effected with interposition of the proxy server 4. Data are thus always transmitted from the terminal 1 to the Internet server 7 and from the Internet server 7 to the terminal 1 with interposition of the proxy server 4. If the proxy server 17 already contains the desired data, only a connection between the terminal 1 and the proxy server 7 is effected.

A connection between the terminal 1 and the proxy server 17 (or an Internet server 7) is composed of a chain of data transmission sections which in each case provide a particular bandwidth for a data transmission. In the UPSTREAM channel from terminal 1 to proxy server 17, such data transmission sections are, for example, the ISDN/POTS/GSM/UMTS transmission link of the terminal 1 to an access point 2 of the Internet 3, the individual data transmission sections in the Internet 3 between individual routers of the Internet and the data transmission section by means of which the proxy server 17 is connected to the Internet 3.

In the DOWNSTREAM channel from the proxy server 17 to the terminal 1 which, in the exemplary embodiment shown, is implemented via a satellite link, data transmission sections are the link from the proxy server 17 to the satellite uplink 9, the actual satellite link and the transmission section from the satellite dish 12, 13 to the terminal 1. According to the exemplary embodiment shown, the last section can again be implemented by a multiplicity of subsections, in particular have a transmission link implemented by a television cable from the ground station 12 to the terminal 1 and, as an alternative or additionally, transmission links in a local area network 16 to which the terminal 1 is connected.

In this context, the satellite implements not only one but a multiplicity of data transmission sections which in each case are used by one or by a multiplicity of connections. Different data transmission sections are produced in dependence on the satellite 11a, 11b selected for the data transmission, the transponder used in the satellite 11a, 11b and with regard to the frequency and polarization of the data radiated by a transponder.

The situation is thus that a connection between a terminal 1 and the proxy server 17 (or between a terminal 1 and an Internet server 7, respectivel) can be implemented via a multiplicity of data transmission sections.

In this context, the decision about what chain of data transmission sections or media sequences is used for the connections to the individual terminals 1 is controlled by a management system 5 which is connected to the proxy server 17 in the exemplary embodiment shown. The network management or management system 5 optimizes the communications network and the connections implemented in it.

Into the proxy server 17, an administration unit is integrated which detects, stores and possibly represents and modifies parameters and parameter values of a connection and its individual data transmission sections between a terminal and the proxy server 17 (or an Internet server 7, respectively). The administration unit 4 has a central database 41 which stores the parameters and parameter values of the individual connections between terminals 1 and servers 4, 7. For the management system 5, the database 41 represents a decision space in which an existing target function is maximized or minimized for optimizing the characteristics of the communication network.

It is pointed out that the administration unit 4 does not in any way necessarily need to be integrated into the proxy server 17. The corresponding functionality can also be realized in any other facility of the communication network.

In this context, the administration unit 4, also called media sequence administrator (MS-ADMIN) in the text which follows, does not perform the actual optimization of the communication network but only collects information and stores this information in the central database 41 used by the management system 5. It also controls the media sequences of the individual connections in accordance with inputs from the management system 5.

To obtain information about the state or the parameters and parameter values of the individual data transmission sections of a considered connection to a terminal 1, an administrator 6-1, 6-2, 6-3 is in each case allocated to at least some data transmission sections. Such a local administrator will also be called DT-ADMIN in the text which follows, where “DT” stands for data transmission section.

In the exemplary embodiment shown, three DT-ADMINs 6-1, 6-2, 6-3 are provided. DT-ADMIN 6-1, administers the data transmission sections implemented via satellite. DT-ADMIN 6-2 administers the cable network 15 and DT-ADMIN 6-3 administers the local area network 16. In this arrangement, DT-ADMIN 6-1, 6-2, 6-3 collects information about the area administered in each case, particularly with regard to physical availability, bandwidth, costs of data transmission and possibly other parameters. The corresponding information is transmitted by DT-ADMIN 6-1, 6-2, 6-3 to the MS-ADMIN 4. As well, the data can first be transmitted to terminal 1 and by the latter to MS-ADMIN 4 on the UPSTREAM channel. If the terminal is located in the area administered by DT-ADMIN, this information is also transmitted to MS-ADMIN so that it obtains information about the data transmission section in which an existing connection or one to be extended is to be terminated.

The information thus collected is stored in the database 41 and provided to the management system 5. A connection to be set up to a terminal 1 (the broadband connection to the terminal in the DOWNSTREAM direction is of particular interest in this context) can be set up optimally and with optimal utilization of the communication network on the basis of the known parameters.

The present invention then opens up the possibility of allowing the end customer or user of a terminal 1 to participate in the selection of the media sequence of his connection and to implement wishes with regard to particular qualities or parameters of the connection. To make this possible, at least one message is generated at the administration unit MS-ADMIN 4 which is sent to the terminal 1. The message sent by MS-ADMIN to the terminal will be called DOWNSTREAM-MS-iD-Info in the text which follows. The DOWNSTREAM-MS-iD-Info has at least one of the following information items: the sequence, the data transmission sections currently used in the connection between the server and the terminal (media sequence), at least one parameter and parameter value of at least one data transmission section of this current sequence, at least one alternative sequence of data transmission sections between the server and the terminal and at least one parameter and parameter value of at least one data transmission section of this alternative sequence.

FIG. 2 shows an example of a DOWNSTREAM-MS-iD-Info, the structure and method of representation to be understood only to be exemplary.

At number 1, the DOWNSTREAM-MS-iD-Info contains information about the current media sequence. For example, the individual data transmission sections are reported, at present the data transmission sections from server 7 to proxy server 17, from proxy server 17 via satellite to the cable head station 12, from the cable head station 12 to a LAN 16 and from the LAN 16 to the terminal. Furthermore, at number 2, the in each case current bandwidths of the individual data transmission sections are reported. This shows the user where the “bottleneck” of the transmission link is located. In the exemplary embodiment shown, the satellite link for the bandwidth of 2.3 megabits per second forms the bottleneck.

At number 3, alternative bandwidths on the basis of the current media sequence are reported to the user. In the exemplary embodiment shown, the terminal is informed that the satellite link can also be implemented with a higher bandwidth of 4 megabits per second.

Number 4 specifies the current costs of data transmission, for example per kilobyte download.

Number 5 identifies the increased costs when using an increased bandwidth according to number 3.

Number 6 specifies or offers to the user an alternative media sequence in which, for example, the satellite link is not implemented via satellite 11a but via satellite 11b. At the same time, it is reported what bandwidths are available for this alternative media sequence (number 7) and the costs for downloading data via this alternative media sequence (number 8).

Due to the DOWNSTREAM-MS-iD-Info, the user of terminal 1 can now decide on the basis of reliable data whether a change in bandwidth is desired. For this case, or also only for reporting its current parameters to the MS-ADMIN 4, the terminal generates a message, called UPSTREAM-MS-iD-Info in the text which follows. This message is sent to the MS-ADMIN 4. An example of an UPSTREAM-MS-iD-Info is shown in FIG. 3. It specifies the current media sequence, the current bandwidth (which is determined by the bandwidth of the bottleneck of the data transmission sections used), a desired alternative media sequence, a desired bandwidth for a planned download, desired costs for the downloading of data, technical parameters with regard to the satellite dish used, technical parameters with regard to telephone connection and modem (e.g. bandwidth, protocol used etc.) and parameters with regard to the cable connection, if present.

This information is sent to the MS-ADMIN 4 and stored in the database 41.

A modification of the connection desired by the terminal 1, whether it is with regard to the parameters of the media sequence sent out or with regard to the use of an alternative media sequence—is forwarded by MS-ADMIN 4 for processing to the management system 5 which determines an alternative media sequence or a media sequence with alternative parameters on the basis of the parameters stored in the database 41 and provides control information for implementing an alternative media sequence or alternative parameters, respectively.

This is an optimization process. This shall be illustrated by means of an example. If the user of terminal 1 wishes a bandwidth of 4 megabits instead of the previously obtained bandwidth of 2.3 megabits for the satellite link, it is necessary to change the bandwidth allocation in the corresponding satellite link. According to the DVD-S Standard, a satellite link has a bandwidth of 34 megabits/second. If the end customer is to be provided with a greater bandwidth, the bandwidth must be reduced in other connections of this satellite link.

However, this may not be possible since other end customers have reserved certain minimum bandwidths by prioritization (paying higher fees). It is then necessary to implement a satellite link with an increased bandwidth either via a different transponder or, as shown by way of example in FIG. 1, via a different satellite. In the other satellite, this may again require a modification of the bandwidths implemented there for other connections. A complex optimization of the existing resources is required which is known under the keyword “load balancing” and is here performed by the management system 5 utilizing the data of the central database 41 of MS-ADMIN 4.

For collecting information at the MS-ADMIN 4, it can be provided in an embodiment of the present invention that the MS-ADMIN 4 sends out a DOWNSTREAM-MS-iD-Info packet which does not yet or not yet completely contain the desired information, for example about the bandwidths of the individual data transmission sections. The packet sent out is forwarded by DT-ADMIN to DT-ADMIN where it is in each case filled up with the respective information and finally forwarded to the terminal which then has a DOWNSTREAM-MS-iD-Info packet with the complete information intended for terminal 1.

Furthermore, it is preferably provided, for providing information for the MS-ADMIN 4, that the individual DT-ADMINs 6-1, 6-2, 6-3 regularly also send out UPSTREAM-MS-iD-Info packets which are of comparable structure to the UPSTREAM-MS-iD-Info packet of FIG. 3 but naturally only have information about the respective data transmission section.

The aforementioned exemplary embodiment is only intended by way of example. In principle, networks of arbitrary structure can be provided and the MS-ADMIN can be arranged at any point in the network.

In FIG. 4, the present invention is described more generally. A first telecommunication device (TC device) 700 and a second TC device 100 are shown which can be, for example, in each case a server, a proxy server, a TC system or a personal computer of an end user.

Between the telecommunication devices 100, 700, a communication takes place which can be connection-oriented or connectionless.

Various network sections provide a multiplicity of data transmission sections via which a multiplicity of media sequences can be implemented between the units 700, 100. Forward and reverse channel can be effected via the same media sequence or via different media sequences. An administration unit (MS-ADMIN) 400 with a central database 410 detects a multiplicity of parameters and parameter values of the individual data transmission sections. The corresponding information is provided by local administrators (DT-ADMINs) 600-n, 600-m. A management system 500 performs an optimization of the communication network and of the connections implemented in it. The MS-Admin 400 sends DOWNSTREAM-MS-iD-Info packets of the aforementioned type to the TC device 100 and/or the TC device 700 so that the TC device 100, 700 or its users, respectively, can recognize and possibly modify the current media sequence and its parameters. The TC devices 100, 700 and the DT-ADMINs 600-n, 600-m preferably send UPSTREAM-MS-iD-Info packets of the abovementioned type to the MS-ADMIN 400.

1-29. (canceled)

30. A method of information transmission between a terminal (1) of at least one communication network and an administration unit (“media sequence administrator”) (4) in the communication network for detecting and storing and/or representing and/or modifying the current parameters and parameter values of a connection between the terminal (1) and a server (7, 17) of at least one of the communication networks, via which data are transmitted between server (7, 17) and terminal (1), characterized by the following steps:
detecting current parameters and parameter values of the connection between the server (7, 17) and the terminal (1) at the administration unit (4) and storing the parameters and parameter values in a database (41) of the administration unit (4);
generating one or more messages (DOWNSTREAM-MS-iD-Info) at the administration unit (4), which in each case contain the following items of information:
the sequence or a subset of the sequence of the data transmission sections currently used in the connection between the server (7) and the terminal (1) (media sequence),
at least one parameter and parameter value of at least one data transmission section of this current sequence,
at least one alternative sequence or subset of an alternative sequence of data transmission sections between the server (7) and the terminal (1);
at least one parameter and parameter value of at least one data transmission section of this alternative sequence,
transmitting the message/s (DOWNSTREAM-MS-iD-Info) to the terminal (1),
utilizing the parameters and parameter values of the one or more messages (DOWNSTREAM-MS-iD-Info) at the terminal (1).

31. The method as claimed in claim 30, characterized in that the one or more messages (DOWNSTREAM-MS-iD-Info) are additionally transmitted to one or more administrator/s (6-1, 6-2, 6-3) of the data transmission sections (DT sections) of the connection and are there evaluated and/or supplemented and/or forwarded to the terminal (1).

32. The method as claimed in claim 30 or 31, characterized in that the parameters and parameter values of the current sequence of data transmission sections and the parameters and parameter values of an alternative sequence of data transmission sections of a message (DOWNSTREAM-MS-iD-Info) comprise:
the bandwidths at which data are currently transmitted via the individual data transmission sections and/or the entire media sequence, and/or
the bandwidth which, from the perspective of the administration unit, is available overall for the current transmission of data via the individual data transmission sections and/or the entire media sequence, and/or
the current costs of the transmission of the data to the terminal or, respectively, on the individual data transmission sections, and/or
a maximum bandwidth of an alternative media sequence of data transmission sections to the terminal, and/or
a guaranteed and/or probable bandwidth of an alternative media sequence of data transmission sections, and/or
the costs of the data transmission of an alternative media sequence or on the individual data transmission sections of the alternative media sequence.

33. The method as claimed in claim 30, characterized in that furthermore, in the terminal (1) or the administrator (6-1, 6-2, 6-3) of a data transmission section of the current media sequence, a message (UPSTREAM-MS-iD-Info) is generated and sent to the administration unit (4), which contains at least one of the following items of information:
the media sequence or a subset of the media sequence of the data transmission sections currently used in the connection between the server and the terminal,
an alternative media sequence, desired by the terminal or by an administrator of a data transmission section, for this connection between server and terminal,
a desired current minimum bandwidth or one that is available within a certain future, for the data transmission between the server and the terminal,
desired costs for the data transmission between the server and the terminal,
other desired parameters and/or parameter values of the connection between the server and the terminal,
parameters and/or parameter values of system components which characterize the connection of the terminal to communication networks which enable it to communicate with the server, particularly
information about the parameters of a satellite receiving dish and its current and alternative connection to the terminal,
if the terminal or its user or an administrator of a data transmission section of the current connection of the terminal to the server wishes a modification of the parameters or parameter values of the current connection, information relating to the desired modification.

34. The method as claimed in claim 33, characterized in that the message (UPSTREAM-MS-iD-Info) is initially transmitted by the administrator (6-1, 6-2, 6-3) of a data transmission section to the terminal (1) and from there on to the administration unit (4).

35. The method as claimed in claim 33 or 34, characterized in that the terminal (1) or an administrator (6-1, 6-2, 6-3) of a data transmission section automatically sends out a message (UPSTREAM-MS-iD-Info) as response to a message (DOWNSTREAM-MS-iD-Info) received from the administration unit (4).

36. The method as claimed in claim 33, characterized in that a message (UPSTREAM-MS-iD-Info) is generated at the terminal (1) or by an administrator (6-1, 6-2, 6-3) of a data transmission section and is forwarded to the administration unit (4) when an alternative media sequence between the server (7) and the terminal (1) including a different parameter or parameter value of at least one data transmission section of the current media sequence is desired.

37. The method as claimed in claim 30, characterized in that information is determined and stored in the database (41) of the administration unit (4), relating to the question whether and to what extent modifications of one or more of the parameters and parameter values of the current connection imply or require the modification of parameters and parameter values of other connections of the communication network/s (compound information).

38. The method as claimed in claim 37, characterized in that such compound information is also transmitted by means of the transmitted messages (DOWNSTREAM-MS-iD-Info) to the terminal (1) and/or one or more administrator/s (6-1, 6-2, 6-3) of data transmission sections.

39. The method as claimed in claim 30, characterized in that the messages stored in the database (41) of the administration unit (4) are provided to a management system (5) which optimizes this information in accordance with a predetermined target function for the communication network and its current user requirements and controls any possible modification of the current connection including a modification of its parameters and/or of its parameter values in accordance with this optimization.

40. The method as claimed in claim 33, characterized in that the administration unit (4), on reception of a message (UPSTREAM-MS-iD-Info) from the terminal (1) or an involved administrator (6-1, 6-2, 6-3) of a data transmission section, by means of which the wish for a modification of the current connection is signaled, initiates an analysis of the feasibility of the desired modification and coordinates it itself or releases it to a management system (5) for further coordination.

41. The method as claimed in claim 30, characterized in that the administration unit (4) sends a message (DOWNSTREAM-MS-iD-Info) to the terminal (1) when it proposes and/or initiates a modification of the parameters of its current connection to the server (7, 17) and/or this has taken place, where this modification can have taken place out of the current connection or from outside of it.

42. The method as claimed in claim 41, characterized in that the administration unit (4) indicates to the terminal (1) an alternative and more suitable media sequence for the connection between the terminal (1) and the server (7, 17) when the quality of the data transmission on the current media sequence of the connection to the terminal (1) does not correspond to a predetermined target function.

43. The method as claimed in claim 30, characterized in that at least one data transmission section of the connection between terminal (1) and server (7, 17) is satellite-based.

44. The method as claimed in claim 30, characterized in that at least one data transmission section of the connection between the terminal (1) and server (7, 17) is TV-cable based.

45. The method as claimed in claim 30, characterized in that at least one data transmission section of the connection between terminal (1) and server (7, 17) is LAN-based.

46. The method as claimed in claim 30, characterized in that at least one data transmission section of the connection between terminal (1) and server (7, 17) is WLAN-based.

47. The method as claimed in claim 30, characterized in that at least one data transmission section of the connection between terminal (1) and server (7, 17) is telephony- or ISDN- or GSM- or GPRS- or UMTS- or microwave link-based.

48. The method as claimed in claim 30, characterized in that at least one data transmission section of the connection between terminal (1) and server (7, 17) operates with “short-hold technology” or with “fast circuit-switching technology”.

49. The method as claimed in claim 30, characterized in that the server, from which data are transmitted to the terminal (1), is a proxy server (17).

50. The method as claimed in claim 30, characterized in that data between the server (7, 17) and terminal (1) are transmitted under the supervision of the administration unit (4).

51. The method as claimed in claim 50, characterized in that the administration unit (4) cooperates with the server (17) or is integrated therein.

52. The method as claimed in claim 30, characterized in that the terminal (1) is unambiguously identifiable by IP address and a data transmission from the server (7, 17) takes place to the IP address of the terminal (1).

53. The method as claimed in claim 30, characterized in that the data transmission from the server (7, 17) to the terminal (1) takes place to another address than its IP address, particularly to its MAC address.

54. A communication system for carrying out the method as claimed in claim 30, characterized by the following:
an administration unit (4) which is constructed in such a manner that it detects and stores in a database (41) parameters and parameter values of a multiplicity of connections and their data transmission sections which are in each case present between a terminal (1) and a communication device (7, 17) of the communication network,
a multiplicity of data transmission sections of the communication system,
at least one administrator (6-1, 6-2, 6-3) of a data transmission section which is constructed in such a manner that it sends current parameter values of the data transmission section to the administration unit (4), and
a management system (5) which is constructed in such a manner that it optimizes the communication network with regard to its current requirements on the basis of the information of the database (41) of the administration unit (4), wherein
the administration unit (4) is constructed in such a manner that it generates for an existing connection at least one message (DOWNSTREAM-MS-iD-Info) with at least one parameter and parameter value of at least one data transmission section used currently for the connection or provided as an alternative, and sends this message to the terminal (1) of the considered connection, to be used and represented there.

55. The communication system as claimed in claim 54, characterized in that the administrator (6-1, 6-2, 6-3) of a data transmission section automatically sends the current parameters and parameter values of the data transmission section, at regular intervals or when a parameter or parameter value of the data transmission section changes, to the administration unit (4) which stores this information in the database (41).

56. The communication system as claimed in claim 54 or 55, characterized in that the database (41) represents a central database which, if present, contains parameters and parameter values of a multiplicity of data transmission sections of the communication network.

57. The communication system as claimed in claim 54, characterized in that the administrator (6-1, 6-2, 6-3) of a data transmission section is constructed in such a manner that it first sends the information for the current parameter values of the data transmission section, which it sends to the administration unit (4), to a terminal (1), this information then being transmitted from the terminal (1) to the administration unit (4).

58. An administration unit (4) for carrying out the method as claimed in claim 30, characterized by the following:
means for detecting parameters and parameter values of a multiplicity of connections and their data transmission sections which are in each case present between a terminal (1) and a communication device (7, 17) of a communication network to which the administration unit (4) is connected,
a central database (41) for storing the detected parameters and parameter values, and
means for generating at least one message (DOWNSTREAM-MS-iD-Info) for an existing connection with at least one parameter and parameter value of at least one data transmission section currently used for the connection or provided as an alternative, and for sending the message to the terminal (1) of the considered connection, to be utilized and represented there.
